(19) United States
(12) Patent Application Publication
(10) Pub. No.: US 2003/0208578 A1
(43) Pub. Date: Nov. 6, 2003

(54) Web marketing method and system for increasing volume of quality visitor traffic on a web site

(76) Inventors: Steven Taraborelli, Highlands Ranch, CO (US); Michael DeJonge, Broomfield, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/136,159

(22) Filed: May 1, 2002

(51) Int. Cl. G06F 15/16; G06F 15/173

(52) U.S. Cl. 709/223; 709/201

(57) ABSTRACT

A method for operating a web site that attracts high volumes of quality visitors. The method includes submitting to search engines and directories a main web site. A web metric tool is activated or run for the web site and the web site is served to clients over the Internet. After a review period has elapsed, the visitor data collected by the web metric tool is retrieved and analyzed to determine the effectiveness of the web site configuration. Based on the visitor data, the keywords and other content of the web site is modified and the modified main web site is resubmitted to the search services. The method includes running a ranking tool that provides a ranking of the main web site with the search services, such as based on a keyword. The ranking is then analyzed with the visitor data and the modifying is performed on the cumulative data.

### BACKGROUND OF THE INVENTION

1. Field of the Invention

The present invention relates, in general, to attracting visitors or clients over a distributed network such as the Internet to a particular web site, and, more particularly, to a system and method for marketing and operating a web site to obtain high search engine and directory rankings and to obtain a high volume of interested or relevant traffic at the web site.

2. Relevant Background

The growth of the Internet in recent years has been phenomenal with the number of users increasingly dramatically. The Internet connects users with thousands of content sites using communication protocols (such as Hypertext Transfer Protocol (HTTP)) and site addressing using Universal Resource Locators (URLs) that together create the World Wide Web (the “web”). The web sites typically present documents known as “pages” having content in the form of text and graphics. Often, the pages are formatted using Hypertext Markup Language (HTML) or another language that provides a collection of tags used to mark blocks of text and assign meaning to the blocks (such as a title tag and META tags). Hyperlinks or links are often included in the pages providing a navigable reference, including an URL, to another web site or page. The Internet or web user uses a specialized computer application called a browser to navigate the web that can decode the pages (e.g., HTML files) and display the information contained in each page on the user's monitor.

The dramatic increase in use of the Internet and improvement in reliable content distribution has resulted in a large expansion of commerce and marketing of services and products over the web, with nearly every business having one or more web sites selling or marketing to web users. To sell their products, though, a business needs to first attract the consumers or visitors to their web site, and the attracted visitors preferably are relevant visitors or consumers interested in the product to insure a higher return on investment (ROI) for the web marketing program. Differentiating a web site from the seemingly limitless other competing web sites to obtain high traffic volume and quality visits can be a difficult task for an operator of a web site, e.g., a webmaster.

Web searching services (e.g., Google™, Alta Vista™, and the like) have become the key entry point for web users and assist users in locating specific information, such as a business providing a service or selling a certain product, on the web. These services can be divided into search engines, directories or indexes, or a combination of an engine and an index. Search engines build and maintain large databases of web pages with information being gathered by spiders (i.e., automated applications) that roam the web looking for new pages and by submissions from webmasters. Typically, search engines store the gathered or submitted URL and then read the corresponding page to extract relevant information for storage in their database. Directories or indexes use databases of web sites with the content of a listing in the index generally depending upon what a webmaster submits and not necessarily what is on a corresponding page.

When using a search service, the user typically enters search terms, in natural language or using Boolean logic, and the search service returns and displays a list of results or web pages that the user may access via a hyperlink. The results typically present the web sites based on their ranking for the entered keywords or phrase. In general, users may only visit the highest ranked sites, such as the first 5 to 10 sites or those displayed on the first or second page. Therefore, for a business to successfully attract users to its web site, the web site needs to be ranked highly by the search services. Unfortunately, the ranking methods used by each search service may be unique to the particular search service. For example, one service may only use the keywords and phrases placed in the META tags, such as the title and description tags, and display the contents of these tags as part of the results. Other search services look to the actual content of the page such as in the first paragraph. Still other services use other criteria such as the popularity of the site as evidenced by the number of links to the site from other pages or sites. Therefore, a web site may be highly ranked for a keyword or phrase in one service while receiving a much lower ranking in other services.

Obtaining consistently high rankings is made more difficult as the search services change their ranking algorithm criteria periodically (such as to penalize sites that utilize gateway pages having no or little content to increase their link popularity or to penalize sites that simply repeat keywords over and over). Additionally, a web site's ranking for a keyword or phrase will most likely change as large numbers of competing web sites and pages are added to the web on an ongoing basis. Similarly, the searching terms and industry language used evolves over time and a web site ranking may change for better or worse with such language usage changes.

Webmasters have employed a number of techniques in their attempts to enhance rankings for their web sites with the search services. For example, webmasters often draft META tags upon the creation of a web site with the intent of obtaining a high ranking based on a particular keyword or phrase. However, as discussed above, the webmaster may target a specific search service neglecting the ranking methods of other services, and once created, many web sites are not updated to account for service ranking changes or language usage changes. Some webmasters utilize web traffic analysis applications, such as HitBox provided by WebSideStory, Inc., to examine the volume of visitors to a site, referrers such as search engines to the site, paths navigated by the visitors, and other information for the visitor such as keywords the visitor used to find the site. Other services allow a webmaster to determine for specific keywords how their web site is ranked by the search services, see for example, software provided by AgentWebRanking. While providing useful information, the amount of information can be overwhelming and seemingly unrelated to the form and content of a web page and is often merely used for web site marketing reporting. Webmasters lack a comprehensive tool or system useful for guiding the creation and modifications of websites that provide increased visitor volume and quality and instead have unsuccessfully relied on past experiences and nearly random processes to obtain web site traffic. Web site optimization has become so frustrating that many webmasters have become willing to subscribe to services that charge for referrals or charge for superior rankings sometimes using unscrupulous techniques.

There remains a need for an improved method and system for developing and marketing a web site that effectively increases the visitor volume and the quality of traffic to the web site while conforming to accepted industry practices and techniques within the confines of the search engine algorithms. Preferably, such a method and system would be useful for accounting for changes in ranking methodologies, search and industry language, the changes and addition of competing web sites, and the addition or loss of particular search services. Such a method and system preferably would be relatively simple and inexpensive to implement reducing the need for highly experienced site optimization personnel while increasing the return on investment of web marketing expenditures.

### SUMMARY OF THE INVENTION

The present invention provides a web marketing method that addresses the technical and administrative problems associated with operating a web site so as to garner acceptable results, i.e., relatively high visitor traffic with high quality that provides a satisfactory return on investment. The web marketing method is adapted to overcome deficiencies in prior ad hoc web site optimization practices by providing a coordinated optimization strategy that effectively ties together META tag utilization, site submissions, web traffic analysis, doorway domain web sites, and search engine ranking analysis. These coordinated processes or web site analysis and marketing tools are performed in a step-by-step and related manner. Further, and significantly, these steps are repeated for each managed web site on a periodic basis, such as weekly, monthly, and the like, to enable a webmaster to analyze web site use and effectiveness and then, in response, to update and modify the web site to enhance the volume and quality of web site traffic. In this manner, the web marketing method of the present invention provides a cost efficient and robust process for managing a web site to attract relevant visitors from the numerous search engines and directories.

According to one aspect of the invention, a method is provided for operating a web site that attracts high volumes of quality visitors. The method includes submitting to search services (such as search engines and/or directories) a main web site that has tag content (such as content in META tags such as description and keyword META tags) and body content (such as in a title and first paragraph of an HTML document). A web metric tool is then activated for the downloaded main web site and the web site is served to clients or visitors over the Internet. The method continues with determining whether a web site review period such as 1 week, 2 weeks, 1 month, 3 months and the like has elapsed since initial serving of the main web site. Once elapsed, the visitor data collected by the web metric tool is retrieved and analyzed to determine the effectiveness of the web site configuration. Based on the visitor data, the tag and/or body contents are modified and the modified main web site is resubmitted to the search services.

In some embodiments, the method includes running a search engine ranking tool that communicates with the search services and provides a ranking of the main web site with the search services, such as based on a keyword or phrase relative to other web sites in the search service database or index. The ranking is then analyzed with the visitor data and the modifying is performed on the cumulative web site performance analysis data to obtain higher rankings and visitor volume. The method also may include creating a number of doorway “mini” domain web sites using the same or different keywords and differing body content and providing one or more hyperlinks to the main web site. The method includes serving these doorway domain web sites to clients or visitors (i.e., any users of the Internet), submitting the doorway domain web sites to the search services, and obtaining traffic metrics and search service ranking information on these doorway domain sites. Additionally, the doorway domain sites are periodically reviewed (often concurrently with the review of the main web site), modified based on the review, and resubmitted to the search services.

### BRIEF DESCRIPTION OF THE DRAWINGS

FIG. 1 illustrates a web site management system according to the present invention in an exemplary networked, client-server environment including web marketing analysis tools;

FIG. 2 is a simplified web page that may be presented and managed within the system of FIG. 1;

FIG. 3 is a flow diagram showing the functions carried out by the system of FIG. 1 in modular fashion to launch a main web site and associated doorway domain web sits as well as initiating several web analysis tools; and

FIG. 4 is a flow diagram of a periodic web site review and modification process carried out in the system of FIG. 1 to optimize the effectiveness of the web site in reaching a targeted audience.

### DETAILED DESCRIPTION OF THE PREFERRED EMBODIMENTS

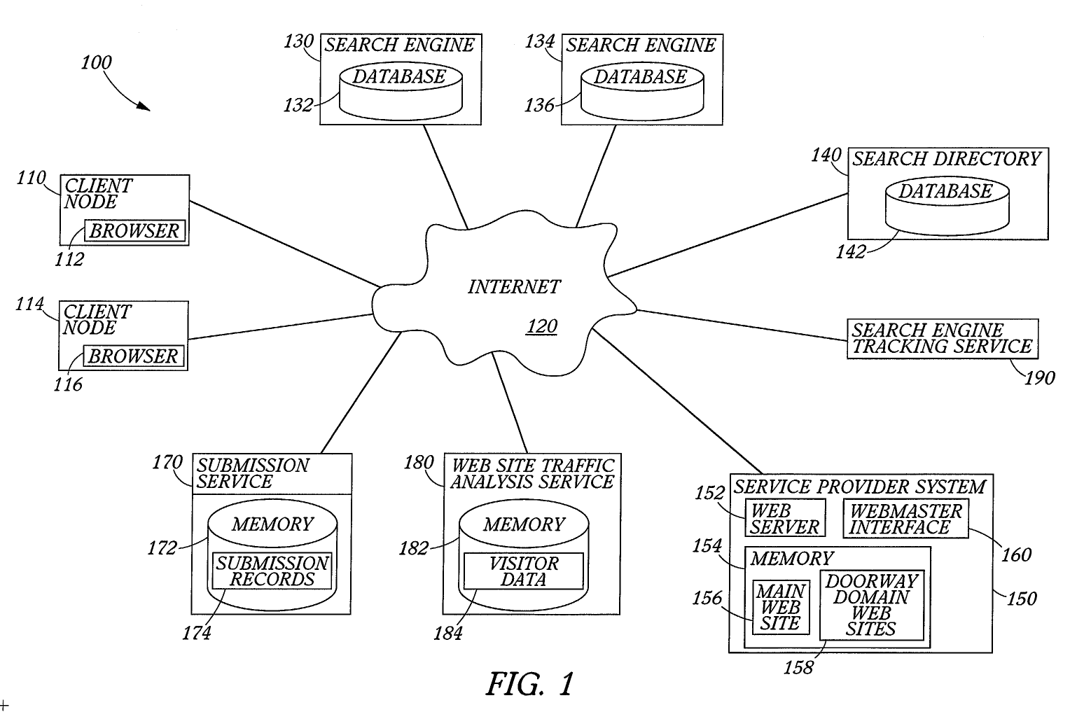

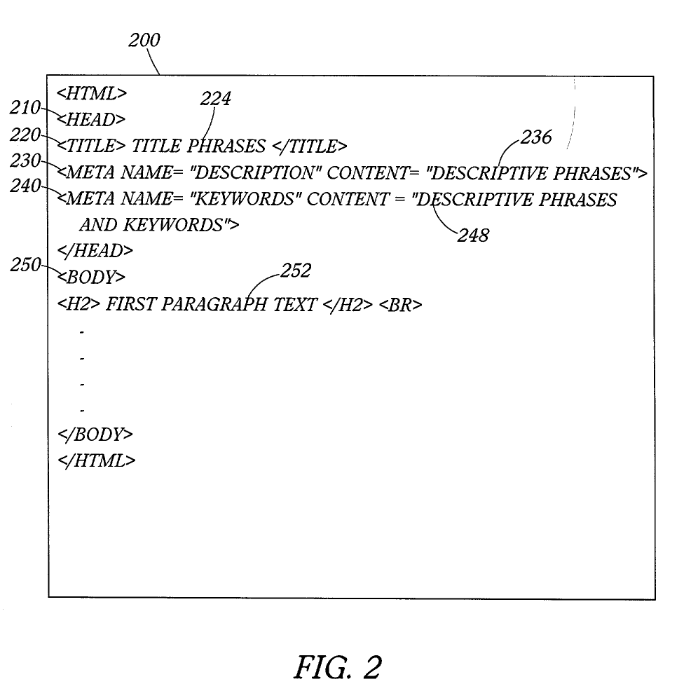

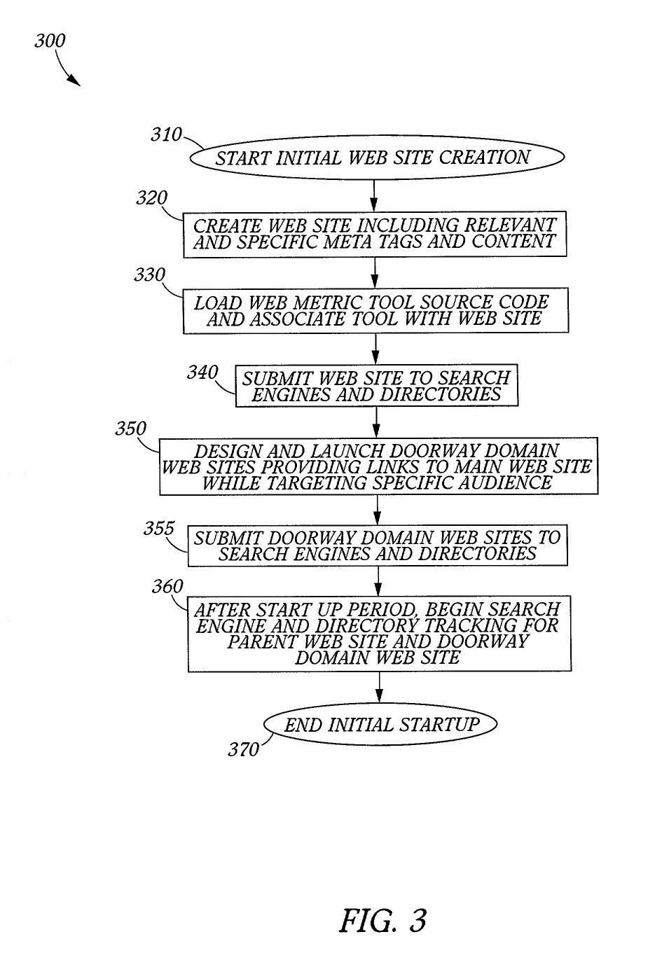

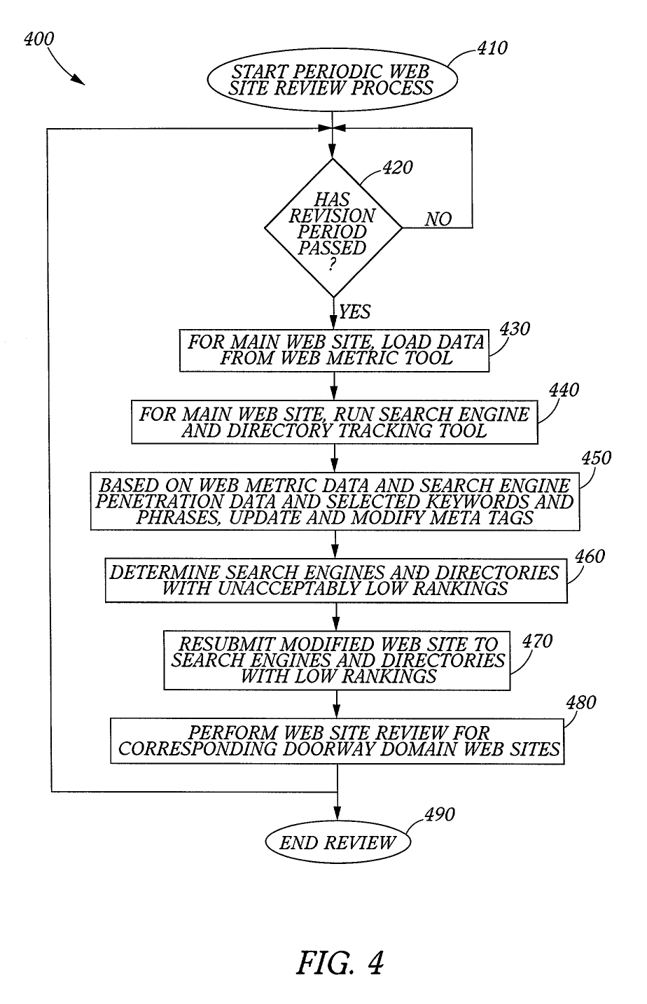

FIG. 1 illustrates one embodiment of a system 100 useful for marketing a web site to search engines and directories to obtain a higher web site ranking and database penetration to increase the quantity and quality of visitor traffic. The functions and operation of the system 100 are described in a client/server, decentralized computer network environment being transmitted over a digital communications network, such as the Internet 120 or more specifically, the web. The description of the system 100 begins with a brief discussion of the components making up the system 100 with reference to FIGS. 1 and 2 and continues with a fuller description of the operation of each component in connection to the operation of the system 100 with reference to FIGS. 3 and 4.

In the following discussion, computer and network devices, such as the service provider system 150, and software applications and memory structures are described in relation to their functions rather than as particular electronic devices and computer and software architectures. To practice the invention, these computer and network devices and software applications may be any devices and software useful for providing the described functions, including well-known data processing and communication devices and systems such as personal computers with processing, memory, and input/output components. Many of the network devices may be server devices configured to maintain and then distribute software and data over the data communications network 120. The communication links between the components and the communications network 120 may be any suitable data communication links, wired or wireless, for transferring digital data between two electronic devices (e.g., a LAN, a WAN, an Intranet, the Internet, and the like). In a preferred embodiment, data is communicated in digital format following standard protocols, such as TCP/IP, but this is not a limitation of the invention as data may even be transferred on storage mediums between the devices or in print out form for later manual or electronic entry on a particular device.

The system 100 includes client nodes 110, 114 connected to the Internet 120 to allow the client nodes 110, 114 to search for web sites and web pages having specific content, such as information on services and goods. To view content on sites or pages, the client nodes 110, 114 include browsers 112, 116. The system 100 further includes search engines 130, 134 and search directory 140. These search engines 130, 134 and search directory 140 may be any of the well-known search services available for use by clients connected to the Internet 120 with each maintaining a database 132, 136, 142 of web site addresses or URLs and relevant information obtained from the site contents and/or from site submissions. As will be understood by those skilled in the art, each of the search services 130, 134, 140 may have differing rules for submissions, differing techniques for gathering and indexing data within the databases 132, 136, 142, and differing methods of searching the databases 132, 136, 142 and ranking search results. The search engines and directories 130, 134, 140 provide a key entry point for the client nodes 110, 114 to web sites accessible via the Internet 120 and during operation respond to search requests by the client nodes 110, 114 by displaying or providing lists of web sites via the browsers 112, 116. The results are typically listed in descending order by the ranking provided by the search engine or directory 130, 134, 140 and provide a link to each site by URL. While only a small number of clients and search services are illustrated, the system 100 typically would include numerous search services and clients.

The system 100 further includes a server provider system 150 representing a computer system operated by an entity or enterprise attempting to market their goods or services via the Internet 120. The service provider system 150 includes a web server 152, memory for storing a main web site 156 and doorway domain web sites 158 associated with the main web site 156, and a webmaster interface (such as a personal computer with a CPU, a monitor, a keyboard, and a browser). The main web site 156 preferably is the organized to be the parent or main access to content and products of the service provider while the doorway domain web sites 158 are preferably mini-web sites with content targeting a subset audience or portion of the service provider market or a unique audience and then directing traffic to the main web site 156 via hyperlinks. The webmaster interface 160 is utilized by an operator or the webmaster to input the initial web sites 156, 158, to communicate with web marketing analysis tools (such as submission service 170, web site traffic analysis service 180, and search engine tracking service 190 as is discussed below) and view analysis data, and to modify the web sites 156, 158.

FIG. 2 illustrates generally the components of a document or page 200 provided at the main web site 156 or doorway domain web sites 158. As illustrated, the page 200 is an HTML document but other languages (such as XML, XHTML, and the like) may be used to create the page 200. The page 200 includes a header 210 including a title 220 with title text or phrases 224 and description and keyword META tags 230, 240 each including descriptive text or keywords and phrases 236, 248. The page 200 further includes a body section 250 including a first paragraph 252 and additional text. The title 220, description and keyword META tags 230, 240, and first paragraph 252 are of particular importance as many search engines place emphasis on the contents of these portions of the page 200 in performing rankings. Hence, the web sites 156, 158 are preferably drafted using relevant keywords and phrases in these portions of the corresponding page 200 targeting a particular segment audience that web site 156 and/or web site 158 will attract (as is explained in more detail with reference to FIGS. 3 and 4). While not shown, other META tags may be included in page 200, such as robots all, revisit, revised, and alt, and when the page 200 is created the purpose of each tag is considered by the webmaster and the content of each tag is preferably provided to meet the marketing goals of the service provider. In addition, tags 220, 230, and 240 may be included on doorway domain web site 158 pages 200 using different wording and keywords.

The system 100 includes a submission service 170 linked to the Internet 120 to facilitate submitting the sites 156, 158 to one or more and preferably all of the search services 130, 134, 140. The services 130, 134, 140 typically allow entities to register or submit the URL for their web sites and sometimes to provide a description of their page and then adds the web site and relevant information to their databases or indexes. Each service 130, 134, 140 may require differing information to add a URL and/or a web site to their databases and may or may not allow automatic addition. While the webmaster via webmaster interface 160 may manually enter the web sites 156, 158 in each search engine or directory attached to the Internet 120, the system 100 includes a submission service 170 and in a preferred embodiment, the service provider system 150 communicates with the submission service 170 to establish an account. The submission service 170 collects submission data for each of the web sites 156, 158 that may be requested or required by the search services 130, 134, 142 during submission and stores the information in the memory 172 in submission records 174. The submission service 170 functions to automatically register the web sites 156, 158 with each search service 130, 134, 140 on the Internet 120 (or those requested specifically by the webmaster via webmaster interface 160). Preferably, the submission service 170 is adapted to list any of the search services 130, 134, 140 that do not allow automatic submission and the webmaster via interface 160 manually registers the web sites 154, 156 with these listed services. A number of automated submission tools are available, such as the tool available at selfpromotion.com, with the particular tool not being limiting of the system 100 and in some embodiments, a submission tool may be provided at the service provider system 150 and operated by the service provider.

The system 100 further includes a web site traffic analysis service 180 linked to the Internet 120 which can be accessed by the service provider system 150 to obtain tracking services and collect web site metrics for use during web site marketing analysis. Again, the specific web metric tool utilized is not limiting to the invention and preferably such a tool would be adapted for collecting for each site 156, 158 data including number of visitors, search engine referrals, keywords used in finding the site, traffic referrals from other sites or pages, site entry, exit, and travel paths, and the like. During site analysis or review (as discussed with reference to FIGS. 3 and 4), the webmaster is able to view this data via interface 160. An exemplary metric tool that can be used for the analysis service 180 is HitBox provided by WebSideStory, Inc.. In this example, an account is established with the service 180 for each web site 156, 158 and once the web page is downloaded onto the service provider system 150, the service 180 is activated (such as by Javascript™ source code or a transparent pixelgif), which senses when each page is accessed by a client node 110, 114 and transmits information to the service 180. The service 180, in turn, gathers the traffic data, processes it into useful form (such as which keywords were used to find the site), and stores the visitor data 184 in memory 182. The webmaster can then transmit requests via the interface 160 to the service 180 and the data is transmitted to the service provider system 150 for quick and ready access. As will become clear, the visitor data or traffic metrics are used by the webmaster in reviewing the marketing effectiveness of the sites 156, 158 and performing site updates and resubmissions.

The system 100 includes the search engine database penetration tracking service 190 linked to the Internet 120 as another web marketing analysis tool to be used by the service provider system 150 in performing web site effectiveness reviews and modifications. A number of search engine ranking or tracking services are available which can be accessed by users to evaluate how their web sites are ranked by each search engine or directory 130, 134, 140 based on a particular keyword or keyword phrase. In some embodiments, the ranking or tracking service 190 is contacted by the webmaster via interface 160 and a ranking request for each of the web sites 156, 158 is performed and data provided on interface 160 for one or more keywords and for one or more of the search services 130, 134, 140. In some embodiments, the tracking or ranking information provided on the interface 160 includes a relative score or comparative ranking of the web sites 156, 158 on a keyword relative to competing or other web sites. During operation of the system 100 (such as during a review process), the webmaster uses the search engine ranking data to select proper modifications to each of the web sites 156, 158 to enhance search rankings.

Referring now to FIG. 3, a description is provided of the operation of the system 100 during initial creation of a main or parent web site 156. Significantly, the initial web site creation process 300 calls for a coordinated usage of the web analysis tools 170, 180, 190 and other traffic enhancing techniques such as creation of doorway domain web sites 158 to create an initially effective web site (i.e., one that is ranked high for selected keywords and phrases by the search services 130, 134, 140). The web site creation process 300 begins at 310 and generally includes a thorough planning of which audience, markets, or groups of customers that are going to be targeted by the web site. This may include selecting a number of keywords or keyword phrases that are to be used in attracting relevant visitors to the site.

Once initial planning is complete, the process 300 continues with a webmaster (with or without the assistance of automated keyword generators) writing and storing in memory 154 a title (such as title 224) and META tags (such as description and keyword META tags). Step 320 may also include drafting the first paragraph and other body content to include one or more of the keywords and phrases. In general, the META tags are written using the latest industry standards and techniques for proper keyword and keyword phrase generation with the goal of attracting a specific target market segment. The process 320 may include listing the most important keywords earlier in the site 156 and within each META tag, title, and paragraph and limiting META tags to less than maximum limits (such as less than 1000 characters).

To monitor the effectiveness of the web site and particularly its selection and placement of keywords and phrases, the system 100 utilizes or incorporates a web metric tool or traffic counter. At 330, the webmaster via the interface 160 contacts the web site traffic analysis service 180 to establish an account for the web site created in step 320. While shown as a separate entity, the service 180 may be run on the provider system 150. Typically, registration with the traffic analysis service 180 includes installing an agent or smaller application on the provider system 150 onto web sites 156, 158 to monitor traffic on the sites 156, 158. Preferably, the traffic counter used at 330 is a stable, low bandwidth traffic counter that can operate transparently to site visitors without adversely affecting site or page performance provided by the web server 152. Once installed on the system 150, the traffic agent (not shown) transmits statistical data to the traffic analysis service 180 each time a visitor accesses the web site 156 and this information is stored in memory 182 as visitor data 184 for later access by the webmaster (see FIG. 4). Although many metrics or statistics may be reported by an analysis service 180, preferably the service 180 will report keywords used to find the site 156, search engine referrals, traffic referrals, number of visitors, and entry, exit and navigation paths and in some cases also report user profiles indicating browser, operating system, screen settings, languages, and other user or visitor information. For example, the metric tracking tool 180 may be HitBox, RedSheriff, or other readily available metric tools (found at HitBox.com and RedSheriff.com).

The initial creation process 300 continues at 340 with the submission of the web site 156 to search engines 130, 134 and search directory 140. While not necessary due to the use of indexing spiders used by many search engines, web traffic is generally significantly enhanced by the submittal of a web site directly to search services. Submission may be selective, but generally it is preferable to submit to all or most of the services that accept submissions to obtain the largest audience for the web site 156. Submission requirements may vary for each of the search services 130, 134, 140 and the webmaster may submit the URL and other requested information for the web site 156 manually. More preferably, the webmaster at 340 registers the web site 156 with an automated submission service, such as submission service 170, that acts to establish an account for the service provider system 150, to request (and store in submission records 174 for use in later submittals) submittal information for the web site that is adequate and effective for each of the search services 130, 134, 140, and then automatically submits the web site to each service 130, 134, 140. It is important that the submission process 340 accounts for unique requirements of each service 130, 134, 140 by customizing, if necessary and/or useful, the submission information and/or format and be current on new search engines and changing submission requirements. Because some services 130, 134, 140 may not allow automated submission (such as smaller regional engines and indexes), the submission service 170 is preferably configured to notify the webmaster via the interface 160 of any such services 130, 134, 140 and the webmaster then manually submits the web site 156. For example, directory 140 may require manual submission (as is typically the case for search directories) and further directory 140 generally will ignore the tags 220, 230, 240 of web site page 200 shown in FIG. 2.

According to an important feature of the process 300, the method accounts for the higher rankings provided by many search services 130, 134, 140 for sites having high link popularity, i.e., do other sites have links to the web site 156 and/or what is the volume of relevant traffic referrals. To increase the link and referral popularity of the web site 156, the process 300 includes step 350 which includes designing and launching a number (such as at least 3 to 5) of “mini” web sites that act as doorway domain web sites 158. These mini web sites 158 preferably have their own URL and own specific content (although some content may replicate that found on main web site 156). Some search services 130, 134, 140 have begun to penalize web sites that utilize virtual links, “link farms,” or non-content pages to try to falsify link popularity. To avoid such penalization and to attract relevant but often slightly unique visitors to the main web site 156, the mini web sites 158 preferably built using steps 320, 330, and 340 with content and keywords targeting audiences having the same or complementary interests as those presented on the main web site 156 (for example, if the main web site markets sporting goods, the mini web sites may target subsets of this market such as golf, soccer, basketball, and the like). The mini web sites 158 preferably include links to the main web site 156 to increase the number of main web site visitors. The use of these mini web sites 158 also supports the goal of achieving “persistent presence” with the search engine rankings that can result in the web master for service provider system 150 dominating the search engine results for one or more keywords or phrases, i.e., having 3 or more web sites in a top ten results listing provided by a search service 130, 134, 140 for a particular search, thereby displacing competitive web sites to a lower search engine page ranking. As with the main web site at 340, the mini web sites at 355 are submitted to search engines and directories, such as by using a submission service 170 and/or with manual submission.

At any time after the main web site 156 and/or the mini doorway web sites 158 have been launched, the webmaster at 360 can begin tracking the effectiveness of the web sites 156, 158 in penetrating the search engines and directories 130, 134, 140 for one or more keywords. At 360, the webmaster via the interface 160 communicates with the search engine tracking service 190 to request engine tracking for one or more of the web sites 156, 158 for a particular keyword. Again, the search engine tracking service 190 is shown as a separate entity (such as a web server) but may be integrated with the service provider system 150. At 360, search service software may be downloaded to the service provider system 150. The search engine tracking service 190 preferably allows the webmaster to input keywords (such as those used in the title and META tags) for the web sites 156, 158 and then the service 190 or its downloaded software spiders or navigates to search services 130, 134, 140 and provides a report to the webmaster, such as an online via interface 160. The final report may take numerous forms but preferably indicates for each submitted keyword and web site 156, 158 the numerical ranking for the web site 156, 158 compared to other web sites for that same keyword or phrase. In this fashion, the webmaster is able to determine how their web site 156, 158 compares to other web sites competing for the same visitors or market and keyword. Examples of useful services are those provided online as AgentWebRanking™ and search engine penetration tools provided by Copernic™ (found at AgentWebRanking.com and Copernic.com).

An important aspect of the invention is that it provides an ongoing, coordinated method 400 shown in FIG. 4 of continuing to use the web site analysis tools of system 100 to modify ineffective (as evidenced by low search engine referral volume or low search service rankings) keywords or phrases and to modify inappropriate (as evidenced by a relatively high volume and engine database penetration but low sales or requests, i.e., irrelevant visitors) keywords or phrases or to otherwise modify the design of a web site. The ongoing or periodic (such as every week, every two weeks, monthly, or some other period) review is also useful for adjusting for new competing web sites, changes in competing web sites, search engine rankings, or industry or technical jargon. Without an ongoing review process 400, a web site that is initially effective in attracting many relevant visitors may become ineffective over time due to the constant updating of the search engine algorithms.

As illustrated, the process 400 is started at 410 with a verification that a set review period or delay period has passed at 420. For example, a monthly review period may be established to provide the search engines 130, 134, 140 adequate time to add a newly submitted web site and to test the market or activity of user of client nodes 110, 114. Once the review period has passed at 420, the review process 400 continues at 430 for the main web site with loading data from a web metric tool. For example, the webmaster via interface 160 can contact the web site traffic analysis service 180 to request a report(s) based on the visitor data 184 for the main web site 156. As stated earlier, the web traffic report preferably will indicate the number of visitors to the site and the paths they use while there and how they got there (i.e., which keywords were used or referral sources including other web sites and search services 130, 134, 140). Typically, this web traffic report is useful for indicating whether a particular keyword or phrase is successfully attracting visitors and whether the attracted visitors are quality or interested visitors.

At 440, the webmaster via the interface 160 contacts the search engine tracking service 190 and runs search engine tracking for the services 130, 134, 140 for the main web site 156 for one or more keywords. The service 190 provides a report for each of the services 130, 134, 140 database penetration reports indicating how the main web page ranks with that service 130, 134, 140 for the submitted keywords or phrases (and other penetration information). At 450, the webmaster processes the web traffic data and the search engine ranking data to determine whether the web site is effectively designed, i.e., are the keywords properly placed within the web site 156, are the keywords properly selected to attract visitors, are the keywords useful for attracting relevant visitors, and the other web site analysis questions or issues. Based on the collected data and the webmaster's analysis, the webmaster modifies and updates the main web site 156 in an attempt to improve the search engine rankings and/or to attract a higher percentage of relevant visitors. This iterative approach enables a webmaster to experiment and fine tune their web site design and of course, the webmaster may decide to make no modifications at 450 if present results are satisfactory.

At 460, the webmaster determines whether to resubmit the revised web site 156 to search services 130, 134, 140. The webmaster may determine at 460 that the current results being obtained by the web site 156 are satisfactory based on the data from steps 430, 440 and skip step 460 and 470. During other runs of process 400, the webmaster may determine that some or all of the search services 130, 134, 140 are not providing acceptable rankings. If so, at 470, the update or modified main web site 156 is resubmitted to specific search engines or more preferably, to most or all search services 130, 134, 140. Again, the webmaster may manually submit the revised web site 156 or more preferably, request a resubmittal be performed by the submission service 170 which automates some or all of the submission process to the services 130, 134, 140. Additionally, at 470, the webmaster updates the submission records 174 for the main web site 156 to reflect changes made at step 450.

Once the main web site 156 has been analyzed, revised as necessary, and resubmitted, a similar review process is performed for the ancillary or doorway domain web sites 158 associated with the main web site 156. More specifically, steps 430, 440, 450, and 460 are performed for some or more preferably, all of the mini web sites 158 in an attempt to optimize or increase the effectiveness of these web sites 158 and to enhance search engine dominance for the service provider for particular keywords or keyword phrases. As discussed previously, the review analysis 400 is an iterative process that is performed periodically, i.e., once every review period, to cause the web sites 156, 158 to be reviewed and updated to improve performance, to adjust for competitive web sites, and changes in the web marketing environment (such as changes to the number or performance characteristics of the search services 130, 134, 140 or search methods used by users of client nodes 110, 114). The review process ends at 490, such as when a web site or sites 156, 158 are dismantled or taken offline.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the specific order of the initialization process 300 or web site review process 400 are not limiting to the invention with some steps readily performed in different order and/or concurrently.

We claim:

1. A web site operating method for attracting a high volume of quality visitors operating clients linked to a communication network, comprising:
first submitting a main web site including tag content and body content to a plurality of search services;
activating a web metric tool for the main web site;
serving the main web site to the clients over the communication network, wherein the web metric tool gathers visitor data for the clients that access the main web site;
determining whether a web site review period has elapsed since the serving;
when the review period has elapsed, retrieving at least a portion of the visitor data for the main web site;
based on the retrieved visitor data, modifying the tag and body contents of the main web site; and
after the modifying, second submitting the main web site to at least a subset of the search services.

2. The method of claim 1, wherein the visitor data includes information indicating keywords in the tag and body contents used by the clients in locating the main web site.

3. The method of claim 2, further including running a ranking tool for at least one of the search services based on one of the keywords, wherein the ranking tool provides a ranking for the main web site with the one search service based on the one keyword.

4. The method of claim 3, wherein the modifying is further based on the ranking for the main web site.

5. The method of claim 1, further including storing a submission record for the main web site and providing the submission record to a web site submission tool, wherein the first and second submitting include using the submission tool to contact and submit the main web site to the search services based on the submission record.

6. The method of claim 5, further including prior to the second submitting, updating the submission record based on the modifying of the main web site.

7. The method of claim 1, further including serving a doorway domain web site to clients over the communications network, wherein the doorway domain web site has an address on the communication network, tag and body content differing from the main web site, and a hyperlink to the main web site.

8. The method of claim 7, further including performing the first submitting, the loading, the determining, the retrieving, the modifying, and the second submitting for the doorway domain web site.

9. The method of claim 1, wherein the search services include search engines and directories providing listings of web sites to the clients based on a search phrase provided by the client.

10. A method of marketing a parent web site to obtain higher rankings with a search engine or directory for a keyword, comprising:
creating a web site document having the keyword in at least one meta tag for the parent web site;
activating a web site traffic tool to gather data on visitors to the parent web site;
submitting the parent web site to the search engine or directory;
creating a plurality of web site documents for doorway domain web sites including the keyword in at least one meta tag and including a link to the parent web site;
submitting the doorway domain web sites to the search engine or directory;
activating a web site traffic tool to gather data on visitors to the doorway domain web sites; and
serving the parent web site and the doorway domain web sites to clients linked to a communications network.

11. The method of claim 10, further including analyzing the visitor data for the parent web site and based on the analyzing, modifying the web site document.

12. The method of claim 11, further including after the modifying submitting the parent web site to the search engine or directory.

13. The method of claim 12, further including running a tracking tool on the search engine or directory for the parent web site based on the keyword, and wherein the modifying is performed based on results from the running of the tracking tool.

14. The method of claim 11, further including analyzing the visitor data for the doorway domain web sites, based on the analyzing modifying the web site documents for the doorway domain web sites, and submitting the modified doorway domain web sites to the search engine or directory.

15. A system for serving web sites to clients over a communications network, the web sites being located by search services that provide a ranked listing of the web sites based on search terms provided by the clients, comprising:
a main web site stored in memory including a document with keywords in meta tags and with content;
a web server linked to the communications network for providing the clients access to the main web site;
a web traffic tool collecting data on the clients visiting the main web site;
a search service ranking tool communicating with the search services and providing rankings for the main web site at the search services for the keywords; and
a webmaster interface for use by an operator for submitting the main web site to the search services and for viewing the web traffic tool data and the rankings for the main web site and, in response, revising the document of the main web site.

16. The system of claim 15, further including an ancillary web site stored in memory including a document with keywords in meta tags, with content differing from the content of the main web site document, and with at least one hyperlink to the main web site.

17. The system of claim 16, wherein at least some of the keywords in the main web site document are included in the keywords in the ancillary web site document.

18. The system of claim 15, wherein the submitting includes establishing a submission record with a submission service and requesting the submission service operates to submit the main web site with the search services.

19. The system of claim 18, wherein the webmaster interface is further used to resubmit the main web site after modification of the main web site document and the submission record.
